(19) United States
(12) Patent Application Publication
(10) Pub. No.: US 2015/0147034 A1
(43) Pub. Date: May 28, 2015

(54) Optical Connector

(71) Applicant: Texas Instruments Incorporated, Dallas, TX (US)

(72) Inventor: Peyman Hojabri, Dallas, TX (US)

(21) Appl. No.: 14/488,135

(22) Filed: Sep. 16, 2014

Related U.S. Application Data
(60) Provisional application No. 61/909,761, filed on Nov. 27, 2013.

(51) Int. Cl. G02B 6/43; G02B 6/42

(52) U.S. Cl. CPC G02B 6/43; G02B 6/4292; G02B 6/4295; G02B 6/425
USPC 385/77; 385/89

(57) ABSTRACT

An optical connector adapted to be attached to an electronics module having optical-electrical conversion electronics and a module optical window. The optical connector has a connector optical window and a port for an optical link that is optically couplable to the connector optical window. The connector optical window is constructed and arranged to optically align with the module optical window when the optical connector is attached to the electronics module.

This application claims the benefit of U.S. Provisional Application No. 61/909,761, filed Nov. 27, 2013, for OPTICAL-ELECTRICAL CONNECTOR INCLUDING OPTICAL WINDOWING AND CLIP CONNECTION, which is hereby incorporated by reference for all that it discloses.

### BACKGROUND

Currently, data signals that are to be received or transmitted by electronic devices such as computers, integrated circuit packages, imaging devices, etc., are generally in the form of electronic signals. Electrically conductive media, such as copper wire, are typically used to conduct the electronic signals. In some cases the conductors are located within a relatively small area, for example, a circuit board having copper traces connecting integrated circuit dies and other electronics mounted on the circuit board. In other cases the conductors extend over very large distances such as, for example, buried or suspended wires.

In recent years optical media, such as fiber optic cables and light pipes, sometimes referred to herein as “optical links,” have begun to compete with electrically conductive media for signal transfer. One reason that optical media have grown in acceptance is that at high data rates, some conductive media, such as copper, experience data loss problems and generate a significant amount of heat. The energy needed to transmit data over copper wires is typically proportionately greater than the energy required to transmit data over fiber optic cables. Fiber optic cables are also proportionally thinner and weigh less than wire cables needed to transmit the same amount of data at the same rate.

For the above reasons, data is in many cases transferred from one data location to another in the form of optical signals. One way of transmitting optical signals is to integrally (permanently) connect one end of an optical cable to a portion of an electronics module that converts electronic signals to optical signals (“TX”). The other end of the optical cable is connected to a portion of another electronic module that receives the optical signals and converts the optical signals back to electronic signals (“RX”). One problem with integrally connecting optical cables to electronic modules is that the optical cable or one of the electronic modules at either end thereof may become damaged. In such a situation, it is usually necessary to replace the optical cable and both integrally connected modules, even though only one of these three components is actually damaged. A similar situation arises when either the optical cable or the conversion electronics need to be upgraded. Rather than just upgrading the conversion electronics or the optical cable, the entire assembly of electronics modules and the integrally connected optical cable must be replaced.

In order to provide high-speed optical data transfer between electronic devices that do not have internal signal conversion electronics, an optical cable can be equipped with an electronic-signal-to-optical-signal (“TX”) converter at one end and an optical-signal-to-electronic-signal (“RX”) converter at the opposite end. These cable end converters are then connected to electronic signal outputs and inputs of electronic devices, e.g., integrated circuit packages, computers and computer peripherals, between which data is to be transferred. Since electronic data must be converted to optical data at one end of an optical cable and then must be converted from optical data to electronic data at the other end of the cable, the converters in many cases determine the overall data transfer speed between the two electronic devices.

### BRIEF DESCRIPTION OF THE DRAWINGS

FIG. 1A is an isometric view of a prior art integrated circuit package with optical cables integrally connected thereto.

FIG. 1B is an isometric view of a prior art optical cable having optical-electrical conversion electronics incorporated into plug in adapters provided on the ends of the cable.

FIG. 2 is an isometric bottom view of an integrated circuit package.

FIG. 3 is an isometric top view of the integrated circuit package of FIG. 2, showing optical windows at a top portion thereof.

FIG. 4 is a bottom rear isometric view of an optical connector adapted to be attached to the integrated circuit package of FIGS. 2 and 3.

FIG. 5 is a schematic cross-sectional side elevation view showing the optical connector of FIG. 4 attached to the integrated circuit package of FIGS. 2 and 3 wherein the integrated circuit package is mounted on a printed circuit board.

FIG. 6 is an exploded integrated circuit package and optical connector assembly that includes an integral electrical connector assembly.

FIG. 7 is an isometric view of and assembly including two optical connectors connected to opposite ends of an optical cable and two electronic modules to which the optical connectors are attachable.

FIG. 8 is an exploded isometric view of a wideband optical crosspoint module and an optical connector module.

FIG. 9 is a schematic isometric view of an optical connector and an electronic device to which the optical connector is adapted to be connected

FIG. 10 is a flow chart of a method of optically connecting system components.

### DETAILED DESCRIPTION

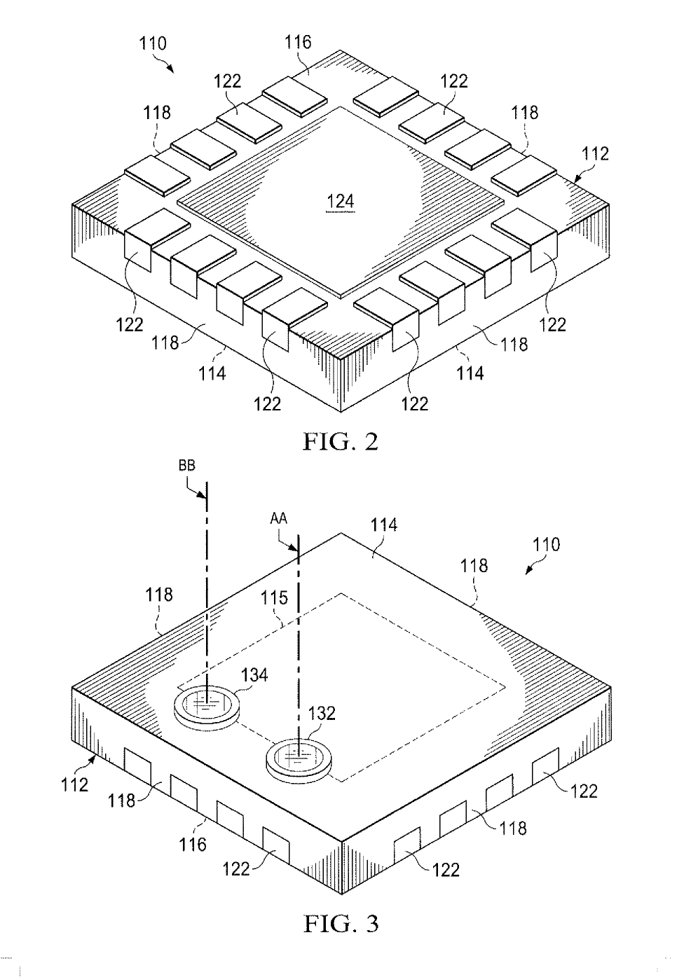

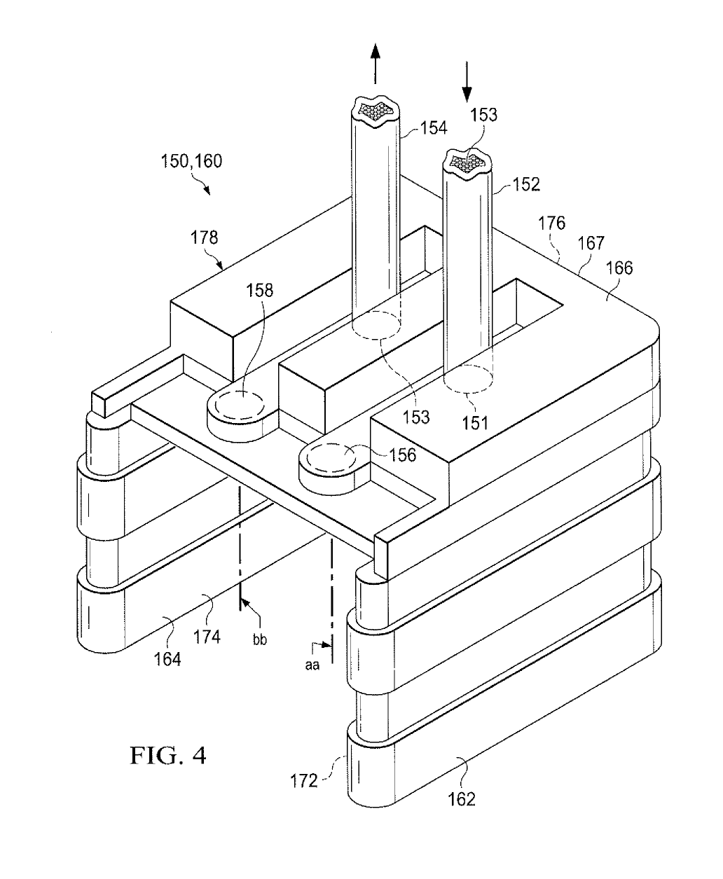

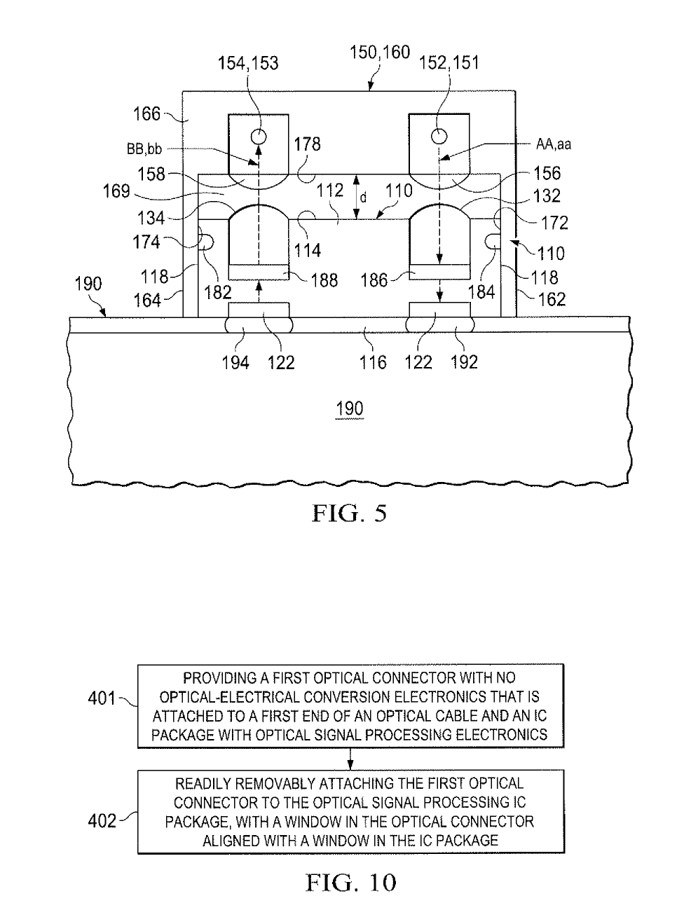

This specification, in general discloses an optical connector 150, FIG. 4, adapted to be attached to an electronic module 110, FIGS. 2 and 3, having optical-electrical conversion electronics 115 and at least one module optical window, e.g. 132. As best shown in FIG. 5, the optical connector 150 has a connector optical window, e.g., 156, and a port, e.g., 151, for an optical link, e.g., 152, that is optically couplable through the connector optical window 156 to optical conversion electronics 186 in the electronics module 110. The connector optical window 156 is constructed and arranged to optically align with the module optical window 132 when the optical connector 150 is operably attached to the electronics module 110.

Having thus described a new electronics module and optical connector generally, various embodiments thereof will now be described in detail. The prior art will also be briefly described.

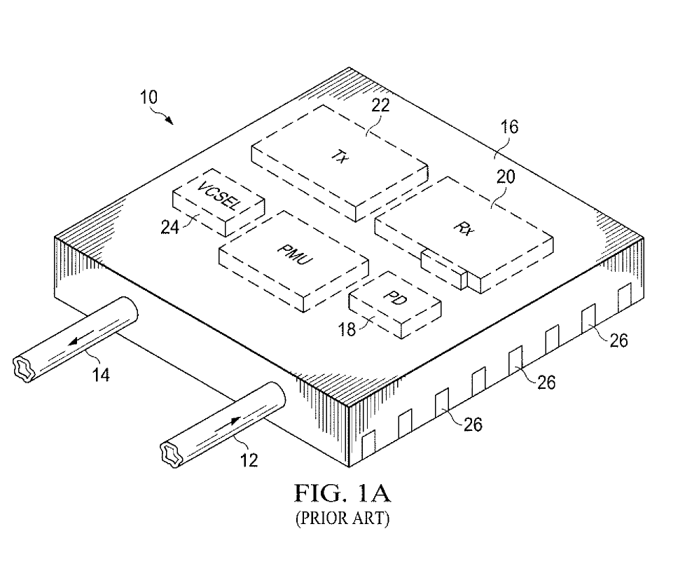

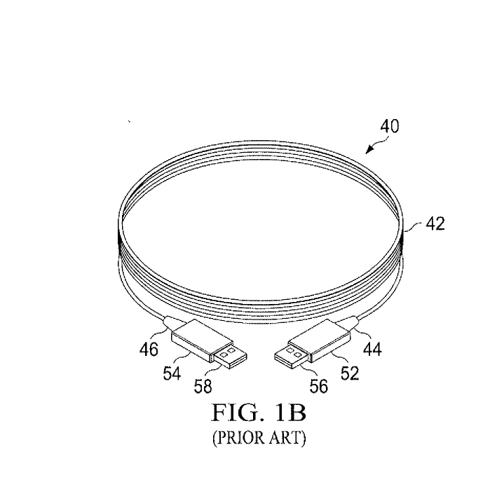

FIG. 1A illustrates a prior art electronics module, in this case an integrated circuit (“IC”) package 10 that has an integrated fiber optic input cable 12 and an integrated fiber optic output cable 14. (The terms “electronics module” and “electronics device” are used interchangeably herein to refer to any device that uses electronic data signals in its operation.) The IC package 10 includes a block of cured mold compound 16 that protectively covers various electronic components therein, including optical-electrical conversion electronics. Some of these electronic components include a photodiode 18 and other circuitry 20 that collectively receive the optical signals from optical cable 12 and convert these signals from optical to electronic (“RX”). Other electronic components include electronic to optical signal conversion circuitry 22 and a vertical-cavity surface-emitting laser (“VCSEL”) 24 that collectively receive electronic signals generated by or received by the IC package from other electronic devices (not shown) and convert these signals from electronic to optical (“TX”) and then transmit the optical signals through cable 14. As used herein the phrase “optical-electrical conversion electronics” refers to either TX or to RX or to both TX and RX conversion electronics.

Optical signals transmitted to and from an electronics module 10 (that may be an IC package) are transmitted by fiber optic cables 12 and 14, respectively. Electronic signals transmitted to and from the module 10 are transmitted by contacts 26 that are exposed at a lower portion of the mold block 16. Contacts 26 are typically soldered to a printed circuit (“PC”) board (not shown) or to other electrical connectors or components (not shown). In other embodiments (not shown), rather than having contacts 26 that are soldered to a PCB, the electronics module 10 has an electrical cable receiving port (not shown) for operably receiving an electrical cable (not shown). The electrical cable is used to connect the module to other electronic devices and transmits electronic signals between the electronics module and the other electronic devices.

FIG. 1B illustrates an optical link assembly 40 that includes an optical cable 42 having opposite first and second ends 44, 46. The optical cable 42 includes two sets of optical fibers. The first set of optical fibers transmits optical signals in one direction and the second set of optical fibers transmits optical signals in the opposite direction. The first end 44 of the optical cable 42 has a first plug in connector assembly 52 coupled thereto and the second end 46 has a second plug in connector assembly 54 coupled thereto.

In the illustrated embodiment, each of the plug-in connector assemblies 52, 54 comprise a USB male terminal 56 or 58 that is adapted to be inserted into a corresponding USB female terminal of an electronic apparatus. Each connector assembly also includes electronics, such as those described with reference to FIG. 1. As described in FIG. 1, one set of electronics is associated with first set of optical fibers in the connected optical cable 42. The first set of electronics (RX electronics) receives an incoming optical signal transmitted through the first set of optical fibers and converts it to an electronic signal. The electronic signal is transmitted to a connected electronic device (not shown). The second set of electronics (TX electronics) is associated with the second set of optical fibers in cable 42. The second set of electronics receives an electronic signal from a connected device and converts it to an optical signal that it transmits through the second set of optical fibers. Thus, electronic signals output from a first electronic device (not shown) are converted to optical signals in the attached first connector 52. These optical signals are transmitted through the optical cable 42 to the second connector 54. The second connector converts these optical signals back to electronic signals in the second connector 54. The second connector 54 transmits the electronic signals to a second electronic device (not shown) connected to the second connector 54. The set of optical fibers connected at one end to the RX electronics of the first connector 52 are connected at the other end to the TX electronics of the second connector and vice verse with respect to the second set of optical fibers.

FIGS. 2 and 3 are isometric views of an example embodiment of applicant's new electronics module, which in one embodiment is an integrated circuit (“IC”) package 110. The IC package 110 comprises a cured mold compound block 112, which may be an epoxy block, having a top portion 114 a bottom portion 116 and four lateral side portions 118. The block 112 may have a generally rectangular box shape with predetermined dimensions. A plurality of electrical contact surfaces 122 are exposed at the bottom portion 116 and lateral side portions 118 of the package 110. The bottom surface of a die pad 124 may be exposed at the bottom portion 116 of the package 110. An optical signal input window 132 having a central optical axis AA and an optical signal output window 134 having an optical axis BB are mounted on the top portion 114 of the IC package 110. The IC package 110 contains optical-electrical conversion electronics that may be similar or identical to electronics in the prior art, such as the IC package 10 shown in FIG. 1. One difference between IC package 110 and prior art package 10 shown in FIG. 1 is that IC package 110 receives and transmits optical signals through the windows 132 and 134 rather than through integrally connected fiber optic cables, such as 12 and 14 shown in FIG. 1.

FIG. 4 is a bottom isometric view of an optical connector 150 and FIG. 5 is a cross sectional elevation view thereof. The optical connector 150 has a first port 151, which is adapted to receive a fiber optic input cable 152. The optical connector 150 also has a second port 153 that is adapted to receive a fiber optic output cable 154 therein. An optical input window 156 with a central optical axis aa and an optical output window 158 with a central optical axis bb are provided at a lower portion of the optical connector 150. These windows 156, 158 may be operatively associated with any of a number of now known or later developed optical structures that are adapted for operably transmitting optical signals, including but not limited to lenses, prisms, waveguides and mirrors. The optical connector 150 may comprise an inverted U-shaped clip member 160. The clip member 160 has a first leg portion 162, a second leg portion 164 and a body portion 166 that connect the first and second leg portions 162, 164. The first leg portion 162 has an inner side surface 172 that is adapted to engage one lateral side portion 118 of the IC package 110. The second leg portion 164 has an inner side surface 174 that is adapted to engage the opposite lateral side portion 118 of the IC package 110. The engagement between the leg portions 162, 164 and the lateral side portions 118 place the optical windows 156, 158 in aligned registration with the optical windows 132, 134 in the IC package 110. The output window 156 receives and transmits optical signals received through input cable 152. The optical input window 158 is similarly associated with optical output cable 154.

As best shown by FIG. 5, an electronics module facing surface 178 of the body portion 166 of the clip 160 is positioned at a predetermined distance “d” above the top portion 114 of the IC package 110. This predetermined distance d between surface 178 and surface 114 may be maintained as by detent balls 182, 184 provided on the leg portions 162, 164 that are adapted to be received in corresponding indentations in the lateral side portions 118 of the IC package 110. Various other means of quickly and securely vertically, laterally and longitudinally registering the optical connector 150 with the IC package 110 may also be used. For example a vertical wall 169 extending downwardly from a rear edge 167 of the optical connector may be used for longitudinal registration. A tongue and groove structure or threaded holes and screws or other structure may also be used to quickly and securely register the optical connector 150 to the electronics module 110.

The IC package 110 contacts 122 on its bottom surface 116 may be attached as by solder or the like to corresponding contacts 192, 194 of a printed circuit (“PC”) board 190. An optical signal input through fiber-optic cable 152 of the optical connector 150 is transmitted through window 156 in the connector 150 and into window 132 of the IC package 110 where it is subsequently converted from an optical signal to an electronic signal by RX electronics 186. That electronic signal may then be processed by other electronics within the IC package 110 and may thereafter be transmitted to the contact 192 of the printed circuit board 190 or the electronic signals may be sent directly to the printed circuit board 190, which conventionally sends it to other circuitry.

FIG. 5 also illustrates that the PCB 190 may send electronic signals through surface contact 194 thereof and then to corresponding contact 122 of the IC package 110. Then the electronic signal is sent to electrical-to-optical processing electronics (TX) 188, which converts it to an optical signal that is transmitted through window 134 of the IC package 110, then through window 158 of the optical connector 150. The optical connector 150 and optical signal output cable 154 then transmit the optical signal to other connectors and/or other electronics. Various optical components known in the art, e.g., lenses, prisms, etc., may be used to transmit optical signals from or to an optical cable. Such conventional optical components may be used in the optical connector embodiments described herein to transmit light from an input optical cable 152 of the optical connector 150 through aligned windows 156 and 132 to RX electronics in the IC package 110. Similarly such conventional optical components may be used to transmit optical signals from TX electronics 188 in the IC package 110 though aligned windows 134 and 158 to output optical cable 154 of the optical connector 150.

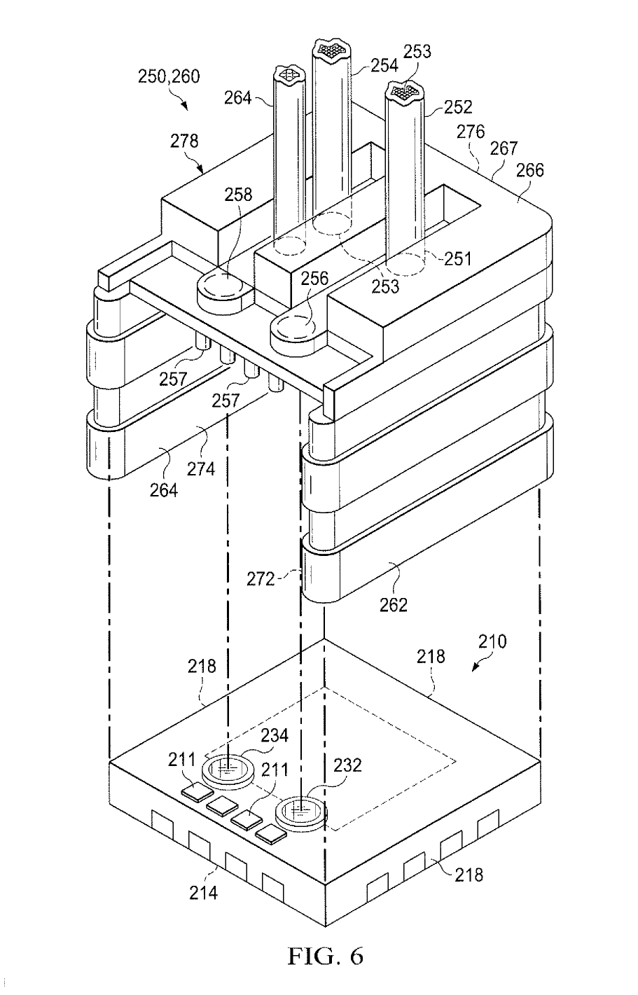

FIG. 6 illustrates alternative embodiments of an optical connector and an electronics module. In FIG. 6 an optical connector/clip member 250/260 has identical structure to that of the optical connectors/clip member 150/160 illustrated in FIG. 4, except that it includes additional electrical connection components. Reference numerals used in FIG. 6 reference the same structure as in FIG. 4, except that all reference numerals in FIG. 6 are 200 series rather than 100 series. Similarly the IC package 210 shown in FIG. 6 is identical to the IC package 110 shown in FIGS. 2 and 3 except that IC package 210 includes additional electrical connection components.

In the embodiment of FIG. 6 the optical connector/clip member 250/260 has electrical contacts that are adapted to engage electrical contacts on the surface of the IC package 210. In the illustrated embodiment the electrical contacts on the optical connector/clip member comprise resiliently displaceable stud members 257, which are generally referred to in the art as “pogo pins.” The IC package 210 has contact pads 211 on the upper surface 214 thereof that are adapted to engage the stud members 257 when the optical connector/clip member 250/260 is positioned in properly engaged/registered relationship with the IC package 210. In this embodiment the optical cables 252 and/or 254 may have conventional electrically conductive wires embedded therein (not shown). In the illustrated embodiment, a separate electrical cable 264, which includes four insulated wires, extend parallel to the optical cables 252, 254. One electrical wire is connected to each of the stud members 257. Various electrical connection structures other than stud members 257 and contact pads 211 could also be used.

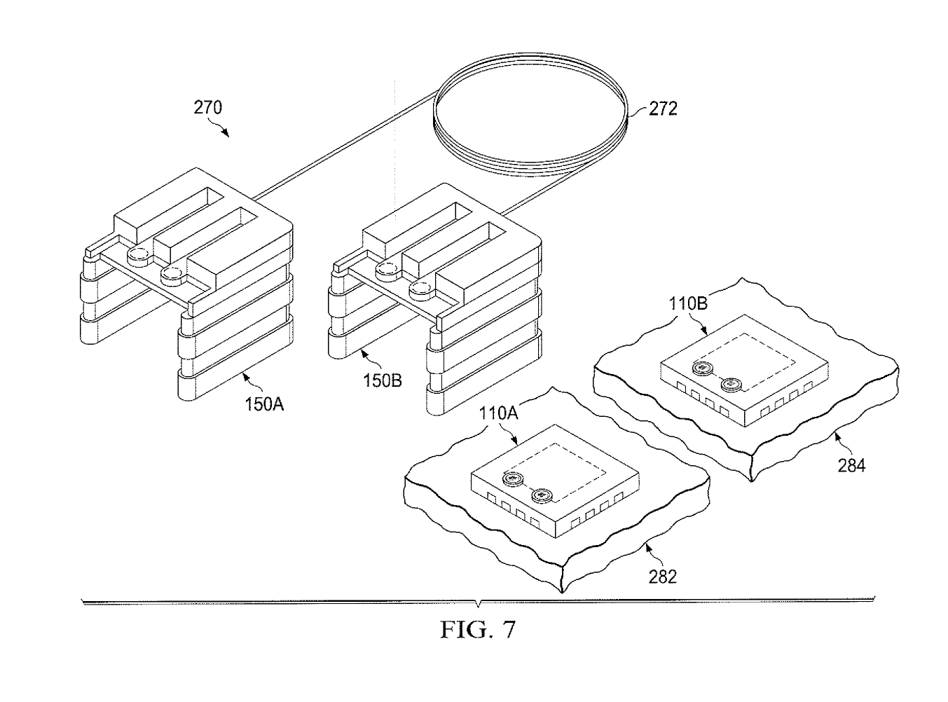

FIG. 7 illustrates an optical connector assembly 270 that includes a first optical connector 150A and a second optical connector 150B, which may each be identical to the optical connector 150 illustrated in FIG. 4. The assembly 270 also includes a fiber optic cable 272 which may comprise a first bundle of optical fibers and a second bundle of optical fibers, such as optical fiber bundles 152 and 154 in FIG. 4. Thus, each of the connectors 150A and 150B have incoming and outgoing fiber optic signals that are transmitted from and to the other optical connector. The first optical connector 150A is adapted to be operably attached to a first electronics module such as integrated circuit package 110A and the second optical connector 150B is adapted to be attached to a second electronics module such as integrated circuit package 110B. The integrated circuit packages 110A and 110B may be mounted upon various electrical structures. For example integrated circuit package 110A may be mounted on a PC board 282 and the second integrated circuit package 110B may be mounted on another PC board 284 or a back plane or other electrical connection device or another electronic module. In another embodiment the first and second optical connectors 150A and 150B are the same as the optical connector 250 illustrated in FIG. 6 and the IC packages 110A and 110B are the same as the IC package 210 illustrated in FIG. 6.

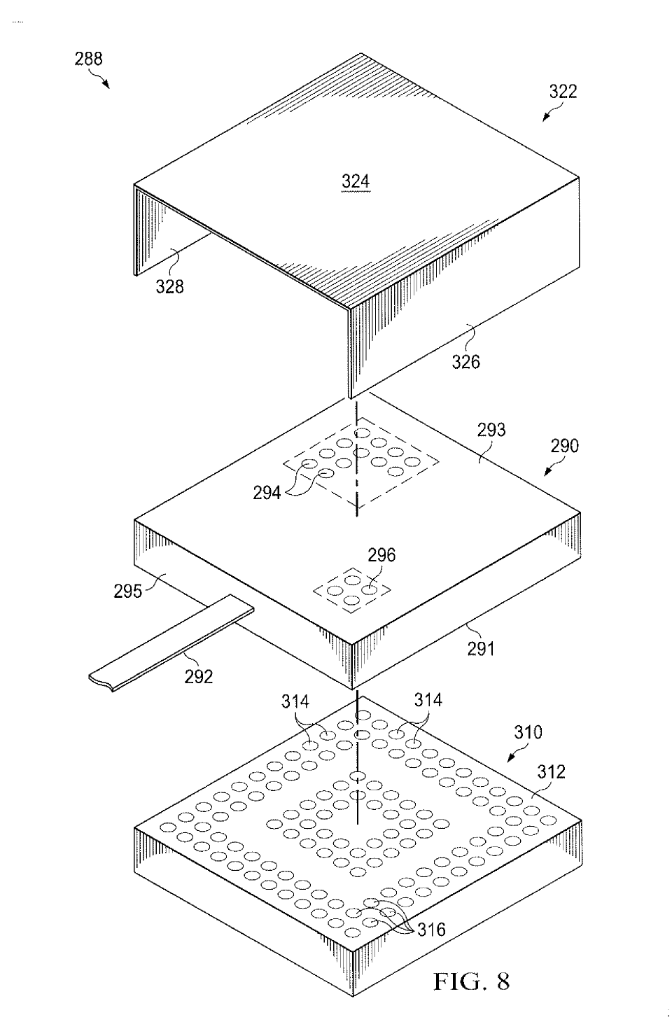

FIG. 8 illustrates another embodiment of an optical connector assembly 288. The assembly 288 includes a generally box-shaped optical connector 290 having a bottom surface 291 and top surface 293. A fiber optic cable 292 is attached to a lateral side 295 of the optical connector 290. The fiber optic cable 292 has a plurality of optical input fibers that are operably associated with input windows 294 on bottom surface 291 of the optical connector 290. Fiber optic cable 292 also has a plurality of optical signal receiving optical fibers that are operably associated with optical signal receiving windows 296 on bottom surface 291.

As also shown by FIG. 8, the optical connector assembly 288 also includes a generally box-shaped wideband crosspoint module 310, which is approximately the same size and shape as the optical connector 290. As known in the art, crosspoints are used for routing incoming signals to specific output signal lines. The crosspoint module 310 has a top surface 312 including a plurality of incoming optical signal windows 314 and a plurality of outgoing optical signal windows 316. The optical connector assembly 288 may also comprise a separate mechanical coupling member 322 having a generally flat body portion 324 and opposite flange portions 326, 328 extending from the body portion 324. The electronics module 290 and wideband crosspoint module 310 may have substantially the same top and bottom footprint such that coupling member 322 may slidingly frictionally engage and hold the two modules 290, 310 in a fixed physical position in which the optical input windows 294 on the electronics module 290 are aligned with the optical signal receiving windows 314 on module 310 and the optical signal receiving windows 296 on module 290 are aligned with optical signal transmitting windows 316 on module 310. The optical fibers are terminated by appropriate structure such as lenses, prisms, etc. such that optical signals are transmitted through each of the aligned sets of optical windows 294, 314 and 296, 316.

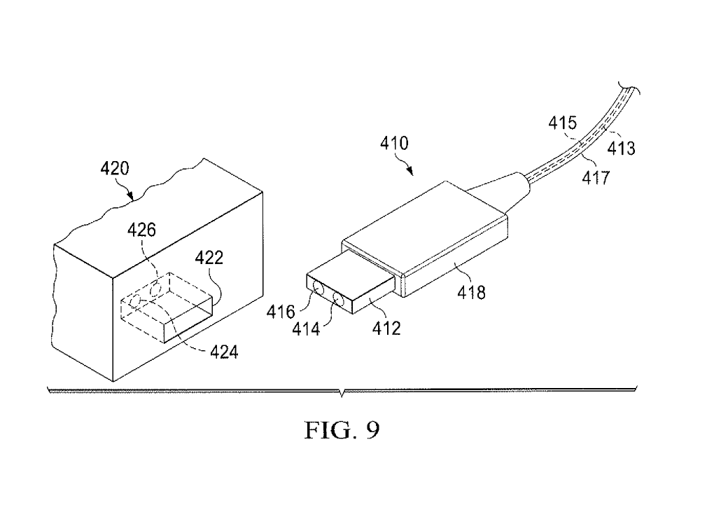

Although certain specific physical structures are described for connecting an optical connector, which has no optical-electrical conversion electronics, to an electronic device that has optical-electronic conversion electronics, various other physical structures may be used to accomplish the same result. For example, as shown in FIG. 9, in one embodiment an optical connector 410 is adapted to be connected to an electronic device 420 that has a female connection socket 422 with two optical windows 424, 426 at an end portion thereof. These windows 424, 426 are adapted to transmit optical signals to and from optical conversion electronics within the electronic device 420. The optical connector 410 includes a stud portion 412 that may be shaped, generally, like the elongate insertable portion of a conventional USB connector cable. Two optical windows 412 and 414 may be provided at its tip. The windows 412, 414 in the tip of the stud member are operably connected to an optical cable having a set of incoming optical fibers 413 and a set of outgoing optical fibers 415.

The optical structures for connecting the two sets of optical fibers 413, 415 to the two windows 414, 416 may be conventional optical structures, which are provided within a connector body portion 418. The socket 422 in the electronic device 420 is adapted to slideably receive the stud member 412 until it is located in a predetermined registration position therewith. In this predetermined registration position, the windows 414, 416 at the tip of the stud portion 412 are operably aligned with corresponding windows 424, 426 in the socket 422. The electronic device 420 has RX and TX electronics operably associated with the first and second windows 424, 426, respectively. The signal conversion electronics in the electronic device 420 may operate in the same manner as described above with respect the assembly of FIGS. 2-4. Another connector (not shown), which may be identical to connector 410 may be mounted at the opposite end of optical cable 416 and is adapted to be received in another electronic device (not shown) having RX and TX electronics therein.

Any number of other physical connection structures that operably align windows in an optical-electrical connector with windows in an electronic device may be used. Non-limiting examples include friction-fit structures, snap-fit structures, hook-and-loop structures, plug-and-socket structures, tongue-and-groove structures, screws, bolts and nuts, cradle structures, semi-tacky adhesives and many other structures and attachment means.

As shown by FIG. 10 a method of optically connecting system components may include, as shown by block 401, providing an optical connector, with no optical-electrical conversion electronics that is attached to a first end of an optical cable, and providing an electronic device that includes optical-electrical signal processing electronics. The method may also include, as shown at block 402, physically attaching the optical connector to the electronic device, with a window in the optical connector aligned with a window in the electronic device. In some embodiments the optical connector is readily removably attached to the electronic device. The phrase “readily removably attach,” as used herein, means to attach in a manner that provides a quick connection and a quick disconnection, e.g. a connection and disconnection that each require less than about 30 seconds by a skilled technician, for example a snap-fit connection or a friction-fit connection.

Certain embodiments of an optical connector assembly and components, and methods of use thereof, have been expressly described in detail herein. Various alternative embodiments of the optical connector assembly, and components and methods of use thereof, may occur to others after reading this disclosure. It is intended that the appended claims be broadly construed to cover such alternative embodiments, except to the extent limited by the prior art.

What is claimed is:

1. An optical connector adapted to be attached to an electronics module having optical-electrical conversion electronics and having at least one module optical window, said optical connector comprising:
at least one connector optical window; and
at least one port for an optical link that is optically couplable through said connector optical window and said module optical window to said optical-electrical conversion electronics;
said connector optical window being constructed and arranged to optically align with said module optical window when said optical connector is operably attached to said electronics module.

2. The optical connector of claim 1 wherein said optical connector comprises no optical-electrical conversion electronics.

3. The optical connector of claim 1 wherein said optical connector is readily removably attachable to said electronics module.

4. The optical connector of claim 3 wherein said optical connector is clippingly attachable to said electronics module.

5. The optical connector of claim 4 wherein said optical connector comprises a generally inverted U-shaped configuration comprising two leg portions connected to a body portion; wherein said at least one connector optical window is mounted on said body portion; wherein said leg portions are adapted to engage opposite lateral side portions of said electronics module; and wherein said at least one connection for an optical link is provided in said body portion.

6. The optical connector of claim 1 wherein said optical connector comprises a stud portion that is insertable into a socket portion of said electronics module.

7. The optical connector of claim 1 further comprising an electrical connector incorporated into said optical connector.

8. An optical connector assembly including:
a first optical connector having no optical-electrical conversion electronics that is adapted to be attached to a first electronics module having optical-electrical conversion electronics and at least one module optical window, said first optical connector comprising at least one connector optical window and at least one port for an optical link that is optically couplable to said connector optical window, said at least one connector optical window being constructed and arranged to optically align with said at least one first module optical window when said first optical connector is operably attached to said first electronics module;
a second optical connector adapted to be attached to a second electronics module and comprising at least one port for an optical link; and
at least one optical link comprising a first end portion that is operably receivable in said at least one port in said first optical connector and a second end portion that is operably receivable in said at least one port in said second optical connector.

9. The optical connector assembly of claim 8 wherein said at least one optical link has said first end portion thereof mounted in said at least one port in said first optical connector and has said second end portion thereof mounted in said at least one port in said second optical connector.

10. The optical connector assembly of claim 9 wherein said first optical connector is attached to said first electronics module and said second optical connector is attached to said second electronics module, wherein electronic signals are converted to optical signals in said first electronics module, wherein said optical signals are transmitted through said first optical connector and said second optical connector to said second electronics module, and wherein said optical signals are converted to electronic signals in said second electronics module.

11. The optical connector assembly of claim 8 wherein said first optical connector comprises a generally inverted U-shaped configuration comprising opposite leg portions and a body portion connecting said leg portions.

12. The optical connector assembly of claim 11 wherein said first optical connector comprises a generally inverted U-shaped configuration comprising opposite leg portions and a body portion connecting said leg portions, wherein said leg portions of said first optical connector are adapted to engage opposite lateral side portions of said first electronics module.

13. The optical connector assembly of claim 12 wherein said at least one optical window of said first optical connector is mounted on said body portion.

14. The optical connector assembly of claim 13 wherein said at least one port provided on said optical connector is provided in said body portion.

15. The optical connector assembly of claim 8 wherein said first and second optical connectors each comprise an electrical connector.

16. The optical connector assembly of claim 8 wherein said first optical connector comprises a stud portion and wherein said at least one connector optical window is mounted in said stud portion.

17. A method of optically connecting system components comprising:
providing a first optical connector that is attached to a first end of an optical cable;
providing an electronics module with optical signal processing electronics; and
readily removably attaching the first optical connector to the electronics module with a window in the optical connector aligned with a window in the electronics module.

18. The method of claim 17 comprising:
providing a second optical connector having no optical-electrical conversion electronics that is attached to the second end of the optical cable; and
readily removably attaching the second optical connector to a second electronics module with a window in the second optical connector aligned with a window in the second electronics module.

19. The method of claim 18 further comprising permanently attaching the first and second electronics modules to first and second circuits.

20. An electronic device comprising:
optical-electrical conversion electronics;
at least one device optical window;
physical attachment structure for attaching an optical connector, having at least one connector optical window and at least one port for an optical link that is optically couplable through said connector optical window and said device optical window, to said optical-electrical conversion electronics.

21. A method of signal processing comprising:
transmitting an optical signal through a window of an optical connector and an aligned window of an electronic device to which the optical connector is attached; and
in the electronic device converting the transmitted optical signal to an electronic signal.

22. The method of claim 21 further comprising:
in the electronic device converting an electronic signal to an optical signal; and
transmitting the optical signal produced by the electronic signal conversion to the optical connector through the aligned windows of the electronic device and the optical connector.

23. The optical connector of claim 1 wherein said optical connector is operably attachable to an electronics module that comprises a crosspoint module.

24. The electronic device of claim 20 wherein said electronic device is an integrated circuit package.
